(19) United States
(12) Patent Application Publication
(10) Pub. No.: US 2006/0096668 A1
(43) Pub. Date: May 11, 2006

(54) Inner magnetic shield material for cathode ray tube and process for producing the same

(76) Inventors: Yoshikazu Yamanaka, Osaka (JP); Hisao Sakamoto, Nara (JP); Kenichiro Kobayashi, Osaka (JP); Sachio Matsuo, Osaka (JP)

Correspondence Address: Russell D Orkin, 700 Koppers Building, 436 Seventh Avenue, Pittsburgh, PA, 15219-1818, US

(21) Appl. No.: 10/518,149

(22) PCT Filed: Jun. 26, 2003
(86) PCT No.: PCT/JP03/08077

§ 371 Date: Sep. 1, 2005

(30) Foreign Application Priority Data
Jun. 28, 2002 (JP) 2002-189867
Jun. 28, 2002 (JP) 2002-189868
Jun. 28, 2002 (JP) 2002-189869

(51) Int. Cl. C22C 1/00; H01J 29/88

(52) U.S. Cl. 148/95; 313/479

(57) ABSTRACT

An inner magnetic shield material for use in manufacturing an inner magnetic shield to be installed inside a color picture tube comprises a steel strip having a coating film of an organic resin which consists essentially of C and H, or of C, H, and O, or of C, H, O, and N on at least one surface of the steel strip, wherein the at least one surface of the steel strip has a surface roughness (Ra) of 0.2-3 μm and the organic resin coating film has a thickness (T) of 0.1-6 μm. Preferably, the ratio T/Ra is in the range of 0.2-4.0. The organic resin coating film contains particles of a wax dispersed therein, wherein the ratio (φ/T) of average particle diameter (φ) of the wax to film thickness (T) is in the range of 0.5-5, and the content of the wax in the film is such that 2-20% of the surface of the coating film is occupied by the wax when the surface is observed under an electron microscope. The organic resin coating film may contain one of (a) at least one coupling agent in a total amount of 2-50 wt % and (b) at least one metal oxide selected from SiO₂, Fe₃O₄, Fe₂O₃, Ni—O, Zr—O, Cr₂O₃, and Al₂O₃ in a total amount of 2-80 wt %, or both.

### TECHNICAL FIELD

This invention relates to a material for an inner magnetic shield, which is a part installed within a cathode ray tube for use in a color television, display unit, or the like, and a method for its manufacture.

### BACKGROUND ART

The basic structure of a cathode ray tube (CRT) (also called a Braun tube) comprises an electron gun and a fluorescent screen which converts electron beams into images, and these parts are housed inside a glass tube formed by joining a panel member and a funnel member.

A magnetic shield member (referred to below simply as a magnetic shield) is disposed on the side of a CRT capable of displaying color images (a color picture tube) in order to prevent deflection of electron beams due to the earth's magnetism. This magnetic shield includes an inner magnetic shield which is installed inside the CRT and an outer magnetic shield which is installed on the outside of the CRT. Materials used for these inner and outer magnetic shields are required to have press workability and the ability to dissipate heat in addition to magnetic properties such as a high permeability and a low coercive force. Normally, cold rolled steel sheet, and particularly aluminum killed steel, silicon killed steel, aluminum trace steel, silicon trace steel, and the like are used as this material. Aluminum or silicon trace steel is a steel in which the content of Al or Si is below detectable limits.

A conventional material for an inner magnetic shield passes through the following steps in the manufacture of an inner magnetic shield and its incorporation into a CRT.

(1) press working of material→(2) washing→(3) blackening treatment→

(4) sealing of a glass tube→degasification of the glass tube

In the press working step (1), a blank punched out of an inner magnetic shield material is formed by bending or drawing to fabricate an inner magnetic shield having a prescribed shape. Spot welding is often performed in this step.

The next step of washing (2) is carried out in order to remove dirt adhering to the material and also to remove (degrease) any rust-preventing oil or lubricating oil which has been applied to the material.

In the blackening treatment step (3), the inner magnetic shield is subjected to heat treatment in a weak oxidizing atmosphere at a high temperature (about 550-590° C.) to form a dense, black iron oxide film primarily comprising magnetite (Fe₃O₄), which is called a blackened film, on the steel surface.

In the subsequent sealing step (4), the inner magnetic shield and other parts are incorporated into the interior of a divided glass tube for a CRT (the panel member and the funnel member), which is then sealed by heating. The heating in the sealing step is carried out in air (or in an atmosphere having a similar composition) at a high temperature in the vicinity of 450° C., which is near the melting point of the glass, and this temperature is maintained for around 40 minutes.

In the final degasification step (5), the interior of the sealed glass tube is evacuated. In this step, the interior of the glass tube is degasified to a vacuum of approximately 10⁻⁵ Torr while maintaining the temperature at around 350° C. This degree of vacuum is indispensable in order for electron beams not to be scattered by gas in the tube, and it directly affects the performance of the CRT.

The blackening treatment in step (3) is performed mainly for the purpose of primary or temporary rust prevention to protect the inner magnetic shield fabricated by press working from rusting until it is incorporated into a glass tube for a CRT. In addition to this primary rust preventing effect, the blackened film which is formed has the effects of increasing heat dissipation by the inner magnetic shield and of preventing irregular reflections of electron beams.

However, since blackening treatment is performed on parts fabricated by press working rather than on steel sheet materials, it is normally carried out by the manufacturers of CRT's (namely, by the users of magnetic shield materials). If blackening treatment is carried out during the manufacturing stage of an inner magnetic shield material, the adhesion of the resulting Fe₃O₄-based blackened film is poor, so it peels off during press working carried out by the users, and the desired corrosion resistance cannot be obtained. Therefore, it is customary for the users of the material to install heat treatment equipment which is used only for blackening treatment and perform blackening treatment themselves. Therefore, the costs of blackening treatment become high.

In order to make costly blackening treatment unnecessary, it has been attempted to impart corrosion resistance to the inner magnetic shield material itself.

For example, JP 6-36702 A (1994) discloses an inner magnetic shield material which is formed by applying thin Ni plating to cold rolled steel sheet, and then performing annealing to form a Ni—Fe diffusion layer at the interface between the plating and the steel sheet. However, in the annealing step following thin Ni plating, it is difficult to control the thickness of the resulting diffusion layer, and corrosion resistance is decreased if diffusion is excessive. Therefore, it is difficult to manufacture a product with consistent quality by this method.

An inner magnetic shield material having a FeO-based blackened film which is previously formed on the surface of a steel sheet by annealing in controlled atmospheres in a continuous annealing line is proposed in JP 2-228466 A (1990). However, the resulting FeO-based film is extremely hard, thereby causing problems such as damage to dies used for press working and shortening of the service life of the dies due to accelerated wear.

JP 2000-504472 A (2000) proposes that the degreasing step be omitted by using a lubricated steel sheet in which a chromate and then a resin are applied to a steel surface and that the degreasing step and the blackening treatment step be omitted by using a lubricated steel sheet in which zinc plating, a chromate, and a resin are sequentially applied to a steel surface. There is no specific description of the resin or the coating formed therefrom.

However, an inner magnetic shield with satisfactory quality cannot be obtained when a conventional lubricated steel strip having a resin coating film is used as a material for manufacturing an inner magnetic shield, as described below.

A conventional lubricated steel strip is not intended for use in a CRT, and it has a resin coating film which is generally too thick for this use. As a result, its weldability is not adequate and may cause poor welding when welding is performed with a low power welding machine such as used by the users of inner magnetic shield materials.

It is desired for the resin to be completely decomposed by combustion during heating in air in the sealing step of a glass tube. However, unless the type and coating thickness are selected suitably, the decomposition of the resin becomes incomplete, or harmful gases are generated from the shield part inside the glass tube, thereby causing fatal problems with respect to the performance of the CRT product.

In addition, if the selection of the type of resin which is applied or the selection of surface treatment of a steel strip which is performed prior to coating with a resin are not appropriate, hematite (rust) is formed on the steel surface when an inner magnetic shield is exposed to a high temperature in air in the sealing step. The hematite is in the form of lamellar (leaf-like) or acicular crystals having a thickness or diameter of around 1 μm and extending vertically from the steel surface, and it easily adsorbs gases. Therefore, the hematite may make it difficult to ensure that an appropriate vacuum for a CRT is achieved in the degasification step. Furthermore, it is easy for these crystals of lamellar or acicular hematite (referred to below as lamellar hematite) to drop off, and if the hematite particles which drop off adhere to the electron gun, there is a danger of the electron gun being broken. Therefore, if the iron oxide film (scale) formed in the sealing step is in the form of lamellar hematite, the service life of the CRT is reduced, so the formation of lamellar hematite is not acceptable to an inner magnetic, shield material.

Thus, there is still a demand for an inner magnetic shield material which is previously imparted with corrosion resistance in order to make it possible to omit blackening treatment by the user, which can be manufactured without treatment such as annealing which is difficult to control, which can be subjected to press working without problems, which exhibits adequate corrosion resistance comparable to that provided by blackening treatment even after press working (which is capable of protecting the material from rusting during storage of an inner shield material and up to the step of sealing a glass tube), and which can prevent the generation of harmful gases and the formation of lamellar hematite in the sealing step.

In the fabrication of an inner magnetic shield, severe press working such as deep drawing may be applied, and it is also desired for an inner magnetic shield material to be imparted with a significantly improved press workability such that it can be subjected to deep drawing such as cupping.

### DISCLOSURE OF THE INVENTION

The present invention provides an inner magnetic shield material having the above-described desirable properties and a method for its manufacture.

The present invention relates to an inner magnetic shield material for use in manufacturing an inner magnetic shield to be installed inside a color picture tube, comprising a steel strip having a coating film of an organic resin which consists essentially of C and H, or of C, H, and O, or of C, H, O, and N on at least one surface of the steel strip.

In one aspect of the inner magnetic shield material according to the present invention, the at least one surface of the steel strip has a surface roughness (Ra) of 0.2-3 μm, the organic resin coating film has a thickness (T) of 0.1-6 μm, and the ratio T/Ra is in the range of 0.2-4.0.

In another aspect of the inner magnetic shield material according to the present invention, the at least one surface of the steel strip has a surface roughness (Ra) of 0.2-3 μm, the organic resin coating film has a thickness (T) of 0;1-6 μm, and this coating film contains particles of a wax dispersed therein, wherein the ratio (φ/T) of average particle diameter (φ) of the wax to film thickness (T) is in the range of 0.5-5, and the content of the wax in the film is such that 2-20% of the surface of the coating film is occupied by the wax when the surface is observed under an electron microscope.

Preferably, the inner magnetic shield material according to the present invention satisfies one or more of the following conditions:

the organic resin coating film contains one of (a) at least one coupling agent in a total amount of 2-50 wt % and (b) at least one metal oxide selected from SiO₂, Fe₃O₄, Fe₂O₃, Ni—O, Zr—O, Cr₂O₃, and Al₂O₃ in a total amount of 2-80 wt %, of both;

the organic resin is combustible for decomposition by heating in air at a temperature of 450° C. or below;

the Si and Al contents ([Si] and [Al], respectively, in wt %) of the steel strip satisfy the following inequalities:
[Si]≧0.02, 0.25≦[Si]+[Al]≦0.55, 0.05≦[Al]−[Si]≦0.35; and

the steel strip has a plated film with a coating weight of 0.1-20 g/m² as a primary coat under the organic resin coating film, the plated film being formed of a metal selected from Ni, Cr, and Fe or an alloy based on the metal.

The present invention also provides a method of manufacturing an inner magnetic shield material comprising forming a coating film of an organic resin consisting essentially of C and H, or of C, H, and O, or of C, H, O, and N on at least one surface of a cold rolled steel strip or pickled hot rolled steel strip.

In one aspect of the above method, the at least one surface of the steel strip has a surface roughness (Ra) of 0.2-3 μm, the organic resin coating film has a thickness (T) of 0.1-6 μm, and the ratio T/Ra is in the range of 0.2-4.0.

In another aspect of the above method, the at least one surface of the steel strip has a surface roughness (Ra) of 0.2-3 μm, the organic resin coating film has a thickness (T) of 0.1-6 δm, and this coating film contains particles of a wax dispersed therein, wherein the ratio (φ/T) of average particle diameter of the wax (φ) to film thickness (T) is in the range of 0.5-5, and the content of the wax in the film is such that 2-20% in area of the surface of the coating film is occupied by the wax when the surface is observed under an electron microscope.

Preferably, the method of manufacturing an inner magnetic shield material according to the present invention satisfies one or more of the following conditions:

the organic resin coating film contains one of (a) at least one coupling agent in a total amount of 2-50 wt % and (b) at least one metal oxide selected from SiO₂, Fe₃O₄, Fe₂O₃, Ni—O, Zr—O, Cr₂O₃, and Al₂O₃ in a total amount of 2-80 wt %, or both;

the cold rolled steel strip or pickled hot rolled steel strip is subjected, prior to the formation of the organic resin coating film, to pretreatment by applying one of (1) an acid selected from hydrochloric acid, sulfuric acid, nitric acid, and mixtures of these and (2) an acidic solution containing ions of at least one metal selected from Ni, Co, Fe, Zr, Sb, V, Mo, and W, or both; and

the cold rolled steel strip or pickled hot rolled steel strip is subjected, prior to the formation of the organic resin coating film or after the pretreatment, to plating with a metal selected from Ni, Cr, and Fe or an alloy based on the metal to form a plated film with a coating weight of 0.1-20 g/m².

The present invention also provides an inner magnetic shield manufactured from the above-described inner magnetic shield material without blackening treatment, and a color picture tube having this inner magnetic shield.

In a series of the above-described steps from the manufacture of an inner magnetic shield through its incorporation into a CRT, as will next be described, an inner magnetic shield material according to the present invention (referred to below as the inventive material) has advantageous properties compared to a conventional inner magnetic shield material which does not require blackening treatment and which has a Ni plated film, a FeO film, or usual lubricating coating (referred to below as a conventional material) or a cold or hot rolled steel strip (referred to below as a bare steel strip) which has been subjected to blackening treatment.

(1) Press Working

The surface of a conventional material having a FeO film is very hard and decreases the service life of the die used in this step. The inventive material has good press workability, and it exhibits further improved press workability particularly when the organic resin coating film contains a wax.

(2) Washing

Among conventional materials, those having a Ni plated film or FeO film have a porous film surface, which can easily adsorb an oil. Therefore, when washing is carried out under the same conditions as for a bare steel strip, the surface is not degreased sufficiently. If degreasing is insufficient, due to the S, Cl, or P-containing ingredients included in a rust-preventing oil or a lubricating oil which is applied to an inner magnetic shield materials corrosive gases are generated in the sealing step, thereby impairing the performance of a CRT. The inventive material has its surface covered with a resin coating film to flatten the surface, so it exhibits degreasing properties which are at least as good as those of a bare steel strip.

(3) Blackening Treatment

With a bare steel strip, expensive blackening treatment is necessary in order to impart rust-preventing properties. The inventive material has corrosion resistance comparable to a blackened film even after rust preventing oil is removed by washing after press working. Therefore, blackening treatment can be omitted.

(4) Sealing of a Glass Tube

With the inventive material, the organic resin coating film undergoes combustion and decomposition during the heating in the sealing step. The organic resin coating film of the inventive material does not include elements such as S, Cl, F, or the like which could generate corrosives gases. Therefore, the gases which are generated by the combustion for decomposition of the resin coating film during heating do not damage the performance of a CRT.

The CO, CO₂, and H₂O gases which are formed by the combustion for decomposition of the coating film maintain the oxygen concentration near the surface of the steel strip in a suitable state in which magnetite can easily form. Thus, with the inventive material, as described later, oxidation proceeds uniformly on a microscopic level, and a magnetite-based black film similar to a blackened film is formed on the surface of the steel strip in a stable manner. Like a blackened film, this film exhibits the effects of increasing heat dissipation ability and of preventing irregular reflections of electron beams.

With any of the conventional materials, lamellar hematite (rust) which adversely affects the performance of a CRT may form during the heating in the sealing step. In contrast, with the inventive material, the formation of lamellar hematite can be prevented by suitably adjusting the steel composition, preferably in combination with an additive to the coating film and/or pretreatment.

(5) Degasification of the Glass Tube

With a conventional material, as described earlier, the vacuum achieved in the degasification step may become insufficient due to the formation of lamellar hematite in the sealing step, thereby making the quality of a CRT unstable. In addition, there is a danger of breakage of the electron gun caused by the lamellar hematite when it drops off. These problems are significantly alleviated or eliminated with the inventive material.

### EMBODIMENTS OF THE INVENTION

Some embodiments of the present invention will be explained below. However, the present invention is not limited to the embodiments disclosed herein, and various modifications may be employed. In the following description, percentages are by mass (wt %) unless otherwise indicated.

An inner magnetic shield material according to the present invention has an organic resin coating film consisting essentially of the elements C and H, or of the elements C, H, and O, or of the elements C, H, O, and N with a thickness of 0.1-6 μm on at least one surface of a steel strip having a surface roughness of 0.2-3 μm Ra.

Preferably, the steel strip is one having excellent magnetic properties. Some examples of such steel strip are strips of aluminum killed steel, silicon killed steel, aluminum trace steel, and silicon trace steel which have conventionally been used for inner magnetic shields. The thickness of the steel strip is preferably in the range of 0.05-3.0 mm in view of the desired strength and workability.

In order to prevent the formation of scale which leads to the formation of lamellar hematite during the step of sealing a glass tube, the steel strip preferably has a Si and Al content ([Si] and [Al], respectively, in wt %) satisfying the following inequalities:
[Si]≧0.02, 0.25≦[Si]+[Al]≦0.55, 0.05≦[Al]−[Si]≦0.35.

Such a steel composition can be attained with a killed steel to which a ferrosilicon and aluminum are added. Preferably, the [Si] and [Al] satisfy the following inequalities:
[Si]≧0.05, 0.30≦[Si]+[Al]≦0.50, 0.10≦[Al]−[Si]≦0.30.

In addition, it is preferable in view of magnetic properties that the contents of C, Mn, P, and S (wt %) be as follows:

| | |
|---|---|
| C: at most 0.005%, | Mn: at most 0.4%, |
| P: at most 0.15%, | S: at most 0.01%. |

It has been found that the Si and Al contents contained in a steel strip affect scale formation under oxidizing conditions which simulate the step of sealing a glass tube. Both Si and Al easily react with oxygen to form an oxide. The oxide, when formed preferentially on the surface of a steel strip, serves to decrease the amount of oxygen supplied to the steel surface, thereby facilitating the formation of an iron oxide film (scale) primarily comprising magnetite, which is similar to a blackened film, rather than hematite which has a higher oxygen content.

For this purpose, a suitable total content of [Si] and [Al] is 0.25-0.55%. With a total content of less than 0.25%, the effect of suppressing the formation of lamellar hematite is insufficient. With a total content of more than 0.55%, a magnetite-based scale is formed, but its adhesion is decreased. In addition, by adjusting the steel composition so as to satisfy [Si]≧2 0.02 and 0.05≦[Al]−[Si]≦0.35, it is possible to ensure that the scale formed in the step of sealing a glass tube is controlled so as to have a magnetite-based composition.

In order to impart corrosion resistance to the steel strip, it is desirable for the organic resin coating film to fill in the surface irregularities of the steel strip and completely cover the surface thereof For this purpose, the thickness of the coating film should be at least 0.1 μm. On the other hand, it is also desirable for the organic resin coating film to be completely decomposed by combustion in the step of sealing a glass tube. The organic resin coating film which was not removed in the sealing step may undergo combusting and decomposition in the subsequent degasification step to generate gases, thereby decreasing the efficiency of degasification. In order for the resin coating film to be completely decomposed by combustion during heating for approximately 40 minutes at around 450° C. in air, which is performed in the sealing step, the thickness of the coating film is at most 6 μm. This thickness is preferably 0.2-4 μm, and more preferably 0.3-3 μm.

If the surface roughness (Ra) of the steel strip exceeds 3 μm, the thickness of the resin coating film necessary to fill in the surface irregularities of the steel strip becomes large. If the resin coating film cannot completely fill in the surface irregularities, corrosion resistance becomes. poor, and it is impossible to prevent the steel strip from rusting. On the other hand, if the thickness of the resin coating film is made too great in an attempt to completely cover large surface irregularities, not only does the amount of gas which is generated in the sealing step increase, but part of the film may remain after the sealing step and adversely affect the degasification efficiency, as described above. Thus, with a material having a surface roughness exceeding 3 μm Ra, it is difficult to control the thickness of the resin coating film so as to satisfy both corrosion resistance and degasification efficiency.

The smaller is the surface roughness of the steel strip, the smaller is the thickness of the resin coating film necessary to fill in the surface irregularities of the steel strip. However, if the surface roughness is less than 0.2 μm Ra, press working is adversely affected due to slippage or sticking of the material. In the press working step, a coiled material is uncoiled and fed through a pair of measuring rolls by a suitable -length for cutting, and the cut material is then punched to form a blank. At this time, if the material is too slippery, slippage occur between the material and the measuring rolls, thus making it impossible to cut the material to an accurate length. In a common tandem press system, a number of punched blanks are stacked one atop another and transported to a press working station, where a single blank is pulled away sequentially to perform press working thereon. At this time, if the blanks stick to each other, a plurality of blanks undergo press working together, which may cause damage to the die or make it impossible to perform working to a prescribed shape. For these reasons, the surface roughness (Ra) of the steel strip is 0.2-3 μm, and it is preferably 0.2-2 μm and more preferably 0.3-1 μm.

It is preferable that the thickness of the organic resin coating film (T) be correlated with the surface roughness of the steel strip (Ra). In order to guarantee corrosion resistance by the coating film which fills in the steel surface roughness, it is effective for the ratio T/Ra to be at least 0.2 and in particular at least 0.4. On the other hand, it was found that spot weldability is impaired if the ratio T/Ra is too high. Spot welding may be utilized when an inner magnetic shield is fabricated after press working. With too thick an organic resin coating film, electric current for welding may not run through the film (leading to a non-conducting weld failure), or abnormal heat generation may occur due to the electric resistance at the surface being too high, resulting in damage to the electrode tips used for welding. The spot weldability begins to deteriorate if the ratio T/Ra exceeds 2.5 and is significantly deteriorated if the ratio exceeds 4.0. Accordingly, the ratio T/Ra is preferably in the range of 0.2-4.0 and more preferably in the range of 0.4-2.5.

The organic resin coating film is a coating film of an organic resin which consists essentially of the elements C and H, or C, H, and O, or C, H, O, and H, so it does not generate a corrosive gas when it undergoes combustion for decomposition. The organic resin coating film is preferably one having a film strength and adhesion such that it will not peel off during press working, and it preferably easily combusts for decomposition in a relatively short period when heated in air at 450° C. so as to be removed during the sealing step.

Examples of a suitable organic resin include urethane resins, acrylic resins, polyester resins, polyolefin resins, polystyrene resins, polyamide resins, and the like.

In order to impart improved press workability permitting deep drawing, the organic resin coating film preferably contains particles of a wax dispersed therein. The wax which is used is such that the ratio (φ/T) of average particle diameter of the wax (φ) to thickness of the organic resin coating film (T) satisfies the relationship: 0.5≦φ/T≦5. If the ratio φ/T exceeds 5, the wax particles are too big relative to the thickness of the coating film so that they drop off easily from the coating film, which not only makes it impossible to attain improvement in press workability, but deteriorates the corrosion resistance. On the other hand, if the ratio φ/T is less than 0.5, the wax particles are too small to substantially achieve improvement in press workability. The ratio φ/T is preferably in the range of 1-3.

The content of the wax is such that 2-20% in area of the surface of the coating film is occupied by the wax when the surface is observed under an electron microscope. If this area percentage is less than 2%, the effect of improving press workability is small. If it is greater than 20%, the material is too slippery and is difficult to deal with as is the case when the steel surface roughness (Ra) is too small. The percent of area occupied by the wax is preferably in the range of 5-15%.

For the same reason as in the case of the resin, the wax preferably consists essentially of the elements C and H, or C, H, and O, or C, H, O, and H. Preferable waxes are synthetic waxes such as polyethylene waxes and fatty acid amide waxes, as well as petroleum waxes such as paraffin wax.

The organic resin coating film may further contain one of (a) at least one coupling agent in a total amount of 2-50% and (b) at least one metal oxide selected from SiO₂, Fe₃O₄, Fe₂O₃, Ni—O, Zr—O, Cr₂O₃, and Al₂O₃ in a total amount of 2-80%, or both of (a) and (b).

The coupling agent is an organometallic compound comprising a metal having hydrolyzable organic groups bonded thereto, and it preferentially reacts with the surface of the steel strip for bonding. A coupling agent has conventionally been used in order to guarantee adhesion between an organic resin coating film and a substrate. According to the present invention, the formation of the above-described lamellar hematite is suppressed by incorporating an appropriate amount of a coupling agent in the organic resin coating film. It is presumed that the metal element in the coupling agent covers the surface of the steel strip to block the supply of excessive oxygen in the sealing step and thus suppress the formation of lamellar hematite.

The coupling agent may be any of a silane coupling agent, a titanium coupling agent, an aluminum coupling agent, and zirconium coupling agent. Two or more coupling agents may be used. The above-described effect cannot be obtained to a substantial degree if the content of the coupling agent is less than 2%. A coupling agent with a content which exceeds 50% significantly increases the viscosity of the resin coating composition which is used in the formation of the coating film. The content of the coupling agent is preferably 3-15%.

The addition of a metal oxide to an organic resin coating film has been performed by adding silica (e.g., colloidal silica) for the purpose of improving corrosion resistance in a low temperature range when such a coating film is applied onto the surface of a zinc-base plated steel strip. The present inventors found that a metal oxide, not limited to silica, when dispersed in an organic resin coating film, serves to suppress the formation of lamellar hematite in the sealing step. It is supposed that the metal oxide in the organic resin coating film remains while the coating resin disappears by combustion in the sealing step, and it gradually covers the surface of the steel strip, which, as a result, is not supplied with excessive oxygen, and the formation of lamellar hematite is suppressed at the surface of the steel.

Thus, the metal oxide in the organic resin coating film does not undergo combustion and decomposition during the sealing step and remains in the inner magnetic shield product, and it is firmly adhered to the surface of the steel strip by the heating applied in the sealing step. The metal oxide is also not gasified in the subsequent steps, so it does not affect the service life of the CRT.

As the metal oxide, at least one substance selected from SiO₂, Fe₃O₄, Fe₂O₃, Ni—O, Zr—O, Cr₂O₃, and Al₂O₃ can be used. The metal oxide is preferably used in the form of a sol or submicron minute particles. Its content in the resin coating film is 2-80 wt %. If its content is less than 2%, the above-described effect cannot be obtained to a substantial degree. The presence of more than 80% of a metal oxide has adverse effects such as a significant increase in the viscosity of the resin coating composition which is used in the formation of the coating film, and a decrease in the adhesion of the coating film. The content of the metal oxide is preferably 5-50%.

The use of either the coupling agent or the metal oxide singly is effective, but the use of both of these is more effective.

The organic resin coating film may be colored with a coloring agent. The coloring agent is selected from ones which do not generate a corrosive gas when combusted.

The organic resin coating film may be formed on one surface of a steel strip as a base material, but preferably on both surfaces thereof.

Next, a manufacturing method for an inner magnetic shield material according to the present invention will be described.

(a) Steel Strip for Use as a Base Material and Its Pretreatment

As a base material, a cold rolled or pickled hot rolled steel strip of a steel having good magnetic properties and preferably having a Si and Al content satisfying the above-described conditions is provided. The steel strip is manufactured in such a manner that its surface on which an organic resin coating film is formed has a surface roughness of 0.2-3 μm Ra.

A cold rolled steel strip is manufactured by passing a hot rolled coil through a continuous cold rolling mill to reduce the sheet thickness to approximately a target value. By using a roll having a dull-finished surface for cold rolling, the steel strip can be provided with a dull surface to adjust its surface roughness to 0.2-3 μm Ra at the time of cold rolling.

The surface roughness of a cold rolled steel strip can also be adjusted by performing temper rolling later on. When the desired surface roughness is relatively large, it may be imparted by shot blasting or similar technique.

Preferably, a cold rolled steel strip is subjected to annealing for recrystallization and growth of the rolled grains, which are in a fiber-like shape due to elongation during the cold rolling. As a result, the magnetic properties of the steel strip are improved. The annealing method may be either box annealing or continuous annealing. In general, the annealing is carried out in a non-oxidizing atmosphere such as an N₂ or N₂+H₂ atmosphere so that the surface of the steel strip is not oxidized, and the annealing temperature is normally 500-900° C. After annealing, temper rolling may be carried out as a final rolling step in order to flatten the steel strip and alleviate stretcher strain and/or to adjust the surface roughness. However, temper rolling adversely affects the magnetic properties of the steel strip. Therefore, it is preferably carried out as lightly as possible or else not carried out.

In the case of a hot rolled steel strip, it is used after it has been pickled in order to remove an oxide film formed by hot rolling. The surface roughness of a hot rolled steel strip can be adjusted by the surface roughness of a finishing roll which is used for hot rolling, for example.

It is preferable that the base steel strip be pretreated before an organic resin coating film is formed thereon. The pretreatment makes it possible to further prevent the formation of lamellar hematite in the step of sealing a glass tube. The reason therefor is presumed to be as follows.

The glass tube sealing step involves heating at approximately 450° C. in air, which causes the steel surface of the inner magnetic shield to oxidize. In general, a steel surface is not uniform on a microscopic level and includes sites which are more susceptible to oxidation and sites which are less susceptible to oxidation. Therefore, the oxidation reaction occurring in the sealing step proceeds unevenly on a microscopic level. As a result, an oxide film having a nonuniform thickness is formed, and at the same time growth of lamellar hematite takes place so that the steel surface appears to be interspersed with a powder of rust. As described earlier, the lamellar hematite (rust) easily drops off, thereby adversely affecting the service life of the CRT.

By rendering the steel surface uniform by pretreatment, the oxidation reaction occurring in the sealing step proceeds uniformly, and the formation of lamellar hematite can be prevented more effectively due to the relatively mild oxidizing atmosphere which is formed by combustion for decomposition of the resin coating. Thus, formation of a magnetite-based black film similar to a blackened film is facilitated.

In order to achieve this effect, the pretreatment is carried out by using one of (1) an acid selected from hydrochloric acid, sulfuric acid, nitric acid, and a mixture of these and (2) an acidic solution containing ions of at least one metal selected from Ni, Co, Fe, Zr, Sb, V, Mo, and W.

Pretreatment with an acid (1) renders the steel surface uniform by removing inactive sites present thereon. On the other hand, pretreatment with a metal ion-containing acidic solution (2) makes the steel surface uniform by remedying active sites with the metal ions. Either pretreatment with (1) or (2) is effective by itself, but a combination of both is more effective. In the latter case, the initial pretreatment may be performed with either (1) or (2), and a step of washing with water may not be performed between pretreatment (1) and (2), although it is possible to perform washing.

The pretreatment is carried out by applying a solution of (1) or (2) to the steel strip. The application may be performed by any convenient technique such as immersion, spraying, and roll coating, although immersion is the simplest. The solution used for pretreatment is preferably at a temperature of from room temperature to 85° C., and a suitable concentration is 0.2-3% for the acid solution (1) and 0.2-50% for the metal ion-containing acidic solution (2). The solution (2) may be an aqueous solution of a metal sulfate, chloride, or nitrate, and it is preferably adjusted to a pH of 2-5 by addition of an acid, if necessary. When application is carried out by immersion, the duration of immersion is preferably from less than 1 second up to approximately 10 seconds.

The pretreated steel strip can be subjected to formation of an organic resin coating film either after washing with water or without washing. By washing with water after the pretreatment, the effect of preventing the formation of lamellar hematite in the sealing step may be improved, particularly in the case of employing pretreatment with both (1) and (2). In any case, the effectiveness of washing can be increased-by using hot water (60-90° C.).

The above-described pretreatment is preferably performed after the steel strip has previously been subjected to alkaline degreasing. Alkaline degreasing serves to remove oil and dirt adhering to the surface of the steel strip and facilitate adhesion of a resin to that surface. Therefore, the resulting-organic resin coating film has improved adhesion. However, alkaline degreasing has little effect on the oxidation reaction occurring in the sealing step, so the above-described prevention of the formation of lamellar hematite in that step can be attained even if alkaline degreasing is omitted. When alkaline degreasing is performed, the steel strip is washed with water before the pretreatment, which is performed with an acidic solution. If alkaline degreasing is carried out after the pretreatment, the effect of the pretreatment is lost, so alkaline degreasing precedes the pretreatment.

In order to render the surface of a steel strip uniform on a microscopic level, the steel surface may be subjected to metal plating as primary coating, instead of the above-described pretreatment. Metal plating as primary coating serves to eliminate nonuniformity of the surface of the steel strip, and due to the coverage of the steel surface with a metal, it has the same effect as is achieved by addition of a coupling agent or a metal oxide to the resin coating film, thus making it possible to effectively suppress the formation of lamellar hematite.

When metal plating is applied as primary coating, the above-described pretreatment may be omitted, but it is possible to perform the pretreatment after metal plating.

The metal plating may be performed with a metal selected from Ni, Cr, and Fe or an alloy based on such metal, and its coating weight is preferably in the range of 0.1-20 g/m². The metal plating as primary coating is preferably performed by electroplating, although other plating methods such as electroless plating may be employed. Unlike the Ni plating described previously with respect to the prior art, this metal plating is not followed by annealing.

(b) Formation of an Organic Resin Coating Film

An organic resin coating film having a thickness of 0.1-6 μm is formed on at least one surface of a steel strip. The organic resin coating film is preferably formed by application of a resin coating composition followed by baking in a conventional manner. However, depending upon the resin, another drying method such as photo-setting or drying at room temperature may be employed. The resin coating composition may be either solvent based or water based, and in the form of a solution, dispersion, and emulsion. From an environmental standpoint, a water-based or aqueous coating composition is preferred.

When the organic resin coating film contains the above-described dispersed particles of a wax and/or one or both of a coupling agent and a metal oxide, the necessary additive or additives are added to the coating composition and dispersed or dissolved therein. The average particle diameter (φ) and the amount of the wax which is added is selected depending on the thickness of the coating film (T) in such a manner that the ratio φ/T and the percent area occupied by the wax are within the prescribed range mentioned previously. The amount of a coupling agent or a metal oxide which is added is selected within the above-described range based on the nonvolatile (solids) content of the coating composition.

From the standpoint of production efficiency and controlling the film thickness, application of a resin coating composition to a steel strip is frequently carried out by roll coating, but other coating methods such as curtain flow:coating, spray coating, and immersion coating can be employed. Baking is carried out at a temperature necessary to harden the coating film, which depends on the particular resin.

From the standpoint of operating efficiency, the above steps are preferably carried out continuously (in a single processing line) on the base material steel strip.

In accordance with the present invention, by employing a means of forming an organic resin coating film which does not require annealing, it is possible to provide an inner magnetic shield material which can be subjected to press working without problems, which exhibits adequate corrosion resistance comparable to that provided by blackening treatment even after press working and thus protects the material from rusting during storage of an inner shield material and up to the step of sealing a glass tube, and which makes it possible in the sealing step to completely combust the resin coating film for decomposition while preventing the generation of harmful gases and the formation of lamellar hematite which leads to a decrease in the service life of a CRT.

### EXAMPLES

### Example 1

A cold rolled steel strip having a thickness of 0.15 mm which was manufactured by hot rolling and cold rolling of a low carbon, aluminum killed steel having the composition shown in Table 1 (remainder: Fe and unavoidable impurities) was used as base material. This cold rolled steel strip was annealed by heat treatment at 800° C. for 5 seconds in an N₂ atmosphere in continuous annealing equipment, after which it was subjected to temper rolling. In this example, the roll used in temper rolling and the rolling conditions were varied so as to adjust the surface roughness of the steel strip.

TABLE 1

| | Element | | | | |
|---|---|---|---|---|---|
| | C | Si | Mn | P | S |
| mass % | 0.002 | 0.01 | 0.25 | 0.009 | 0.003 |

In this example, an inner magnetic shield material was prepared using a cold rolled steel strip having a surface roughness (Ra) of 0.5 μm by subjecting it in a continuous processing line to pretreatment by the procedure shown in Table 2 and then to application of a resin coating composition by roll coating to both sides of the steel strip followed by baking to form a urethane-based organic resin coating film having a thickness (T) of 1.7 μm. Thus, the ratio T/Ra was 3.4.

The conditions for each treatment indicated in Table 2 were as follows:
alkaline degreasing: 1% sodium hydroxide, 60° C., immersion for 2 seconds;
hot water washing: water temperature of 80° C., immersion for 2 seconds;
solution (1): 1% sulfuric acid, 60° C., immersion for 2 seconds;
solution (2): 10% nickel sulfate (pH 4), 60° C., immersion for 2 seconds;

The resin coating composition which was used was a commercially available, aqueous urethane-based resin coating composition, and the conditions for baking after application were 10 seconds at a temperature of approximately 120° C. After baking, the steel strip was air cooled and then coiled.

Each of the resulting steel strips were examined with respect to coatability and reddishness in the following manner.

Coatability

The finished appearance of the material after coating and baking was observed visually to determine the presence or absence of unevenness in coating. In addition, the material was subjected to ultrasonic cleaning in alcohol or trichloroethylene, after which the presence or absence of peeling of the coating film was determined to evaluate the adhesion of the coating film. The results were indicated as follows:

\textcircled{∘}: no unevenness in coating and no peeling of the film by ultrasonic cleaning;

◯: slight unevenness in coating, but with no cissing, and no peeling of the film by ultrasonic cleaning;

×: significant unevenness with cissing, and occurrence of peeling of the film by ultrasonic cleaning.

Reddishness

The material which was coated and baked was subjected to heat treatment in air for 120 minutes at 450° C., and the degree to which the material was reddened (due to the formation of lamellar hematite) was evaluated by visual and microscopic observation as follows:

\textcircled{∘}: no reddishness (reddishness could not be detected either by visual or microscopic observation);

◯: little reddishness (little reddishness could be detected by visual observation);

Δ: slight reddishness (only slight reddishness could be detected by visual observation);

×: significant reddishness (lamellar hematite formed in powder form, and reddishness could be clearly confirmed even by visual observation).

TABLE 2

| Run No. | Procedure of treatment before coating* | | | | Coatability | Reddishness |
|---|---|---|---|---|---|---|
| 1 | degreasing → | washing → | solution (1) → | washing | ⊚ | Δ |
| 2 | degreasing → | washing → | solution (1) | | ⊚ | Δ |
| 3 | degreasing → | washing | | | ⊚ | X |
| 4 | degreasing | | | | ⊚ | X |
| 5 | degreasing → | washing → | solution (2) → | washing | ⊚ | Δ |
| 6 | degreasing → | washing → | solution (2) | | ⊚ | Δ |
| 7 | degreasing → | washing → | solution (1) → solution (2) → | washing | ⊚ | ◯ |
| 8 | degreasing → | washing → | solution (1) → solution (2) | | ⊚ | Δ˜◯ |

*“Degreasing” indicates alkaline degreasing, and “washing” indicates washing with hot water.

As can be seen from Table 2, the reddishness was improved when pretreatment was performed with either solution (1) or (2), and it was further improved when pretreatment was performed with both of solutions (1) and (2). Accordingly, such pretreatment was effective for the purpose of preventing the formation of lamellar hematite (rust) during heating in air at a high temperature. Treatment by only alkaline degreasing could not prevent the formation of lamellar hematite at all. The coatability was good in each case tested.

### Example 2

A urethane-based organic resin coating film was formed in the same manner as described in Example 1 on a cold rolled steel strip which had been pretreated. The cold rolled steel strip, pretreatment method, and the thickness of the resin coating film which were employed were the same as in Example 1. The results of coatability and reddishness evaluated in the same manner as in Example 1 are shown in Table 3.

In this example, pretreatment was performed by the procedure shown in Table 3, and the following four different types of an organic resin coating film were formed:
consisting solely of an organic resin A (indicated by A);
containing a coupling agent B in the resin (indicated by A+B);
containing a metal oxide C in the resin (indicated by A+C); and
containing both a coupling agent B and a metal oxide C in the resin (indicated by A+B+C).

The organic resin A was the resin of the same commercially available, aqueous urethane-based coating composition as used in Example 1, the coupling agent B was a silane coupling agent (γ-glycidoxypropyltrirethoxysilane), and the metal oxide C was colloidal silica. The amounts of the additives were 20% for B and 30% for C based on the total solids content of the coating composition.

TABLE 3

| | | | | | Organic resin | | |
|---|---|---|---|---|---|---|---|
| Run No. | Procedure of treatment before coating | | | | coating film | Coatability | Reddishness |
| 1 | alkaline | hot water | solution (1) → | hot | A | ⊚ | Δ |
| | degreasing → | washing → | | water | A + B | ⊚ | ◯ |
| | | | | washing | A + C | ⊚ | ◯ |
| | | | | | A + B + C | ⊚ | ⊚ |
| 3 | alkaline | hot water | | | A | ⊚ | X |
| | degreasing → | washing | | | A + B | ⊚ | Δ |
| | | | | | A + C | ⊚ | Δ |
| | | | | | A + B + C | ⊚ | ◯˜Δ |
| 5 | alkaline | hot water | solution (2) → | hot | A | ⊚ | Δ |
| | degreasing → | washing → | | water | A + B | ⊚ | ◯ |
| | | | | washing | A + C | ⊚ | ◯ |
| | | | | | A + B + C | ⊚ | ⊚ |
| 7 | alkaline | hot water | solution (1) → | hot | A | ⊚ | ◯ |
| | degreasing → | washing → | solution (2) → | water | A + B | ⊚ | ⊚ |
| | | | | washing | A + C | ⊚ | ⊚ |
| | | | | | A + B + C | ⊚ | ⊚ |

It can be seen from Table 3 that the reddishness was improved when the organic resin coating film contained either the coupling agent B or the metal oxide C and was further improved when the coating film contained both B and C. As a result, improvement in reddishness could be achieved even in the cases where the organic resin coating film was formed on a steel strip after being subjected to only alkaline degreasing without performing pretreatment with the acid solution (1) or aqueous acidic solution (2).

Using a sample which exhibited the most favorable result in reddishness marked \textcircled{∘}, the oxide film formed on the test piece by the heat treatment performed to evaluate reddishness was investigated by X-ray diffractometry. As a result, only those peaks assigned to magnetite (Fe₃O₄) and the base iron (Fe) appeared on the X-ray diffraction pattern. It was thus confirmed that a magnetite-based film was formed by the heat treatment.

### Example 3

An organic resin coating film was formed under the same conditions as the organic resin coating film of A+B+C in Run No. 1 shown in Tables 1 and 2 except that a wax having a varying average particle diameter was further added to the coating film in different amounts.

Thus, a cold rolled steel strip with a surface roughness of 0.5 μm was successively pretreated by alkaline degreasing→washing with hot water→application of solution (1) (sulfuric acid solution)→washing with hot water. Thereafter, in the same processing line, the steel strip was roll-coated with a resin coating composition and baked in the same manner as in Example 1 to form a resin coating film having a varying thickness. The coating composition which was used was the same commercially available, urethane-based aqueous coating composition as used in Example 1, to which the same amounts of the same silane coupling agent and colloidal silica as in Example 2 were added in addition to the wax.

Table 4 shows the average particle diameter of the wax (φ), the thickness of the organic resin coating film (T), the ratio φ/T, the percent area of surface occupied by wax particles (D), and the press workability evaluated by a cupping test which involved deep drawing.

The percent area occupied by wax particles (D) is the fraction in area of the wax determined by observing the surface of the organic resin coating film under a scanning electron microscope (SEM).

The cupping test was performed under the following conditions:
diameter of punch: 50 mm,
draw radius (R) of punch: 2 mm,
draw radius (R) of die: 2 mm
pressure pad force: 500 kgf,
drawing ratio: 1.8.

In this test, the case in which working was possible without problems is indicated by the mark ◯ and the case in which cracking occurred is indicated by the mark ×.

TABLE 4

| | | | | | Press |
|---|---|---|---|---|---|
| | Wax | Film | | % area | workability |
| | diameter, | thickness, | | occupied | by deep |
| Sample | φ (μm) | T (μm) | φ/T | by wax, D | drawing |
| A | 1.0 | 0.5 | 2 | 10 | ◯ |
| B | 0.5 | 0.2 | 5 | 9 | ◯ |
| C | 2.0 | 4.0 | 0.5 | 11 | ◯ |
| D | 1.0 | 2.5 | 0.4* | 10 | X |
| E | 0.5 | 1.7 | 0.3* | 8 | X |
| F | 4.0 | 0.7 | 5.7* | 10 | X |
| G | 1.0 | 0.7 | 1.4 | 10 | ◯ |
| H | 1.0 | 0.7 | 1.4 | 2 | ◯ |
| I | 1.0 | 0.7 | 1.4 | 20 | ◯ |
| J | 1.0 | 0.7 | 1.4 | 1* | X |
| K | 1.0 | 0.7 | 1.4 | 22* | X |

*Outside the preferable range

It can be seen from Table 4 that the steel strip can exhibit improved press workability enabling deep drawing when the ratio φ/T is in the range of 0.5-5 and the percent area of the coating surface occupied by the wax is 2-20%.

### Example 4

Various cold rolled steel strips having different values of surface roughness were subjected to successive treatment in the order of alkaline degreasing→washing with hot water→application of solution (1) (sulfuric acid solution)→application of solution (2) (nickel sulfate solution)→washing with hot water according to Run No. 7 of Table 2 in Example 1. Thereafter, in the same processing line, the steel strip was roll-coated with a resin coating composition and baked in the same manner as in Example 1 to form a resin coating film on the surface of the steel strip.

The coating compositions which were used were based on a urethane resin or a mixture of a urethane resin and an acrylic resin, and they were prepared from commercially available water-based coating compositions. In some test runs, a silica sol was added as a metal oxide to the resin coating composition.

Table 5 shows the surface roughness (Ra) of the cold rolled steel strip, the s type and the thickness (T) of the resin coating film, and the ratio T/Ra.

The press workability, the spot weldability, the corrosion resistance, and the film combustibility of the steel strip were evaluated as follows. The test results are also shown in Table 5.

The conventional materials described above, namely, a material on which a Ni—Fe diffusion layer was formed by annealing after Ni plating (a material of Ni plating+Annealing) and a material on which a blackened film primarily comprising FeO was formed by three heat treatment steps (a material with a FeO-based blackened film) were tested in the same manner. The test results of the conventional materials are also shown in Table 5.

Press Workability

Each coiled inner magnetic shield material was subjected to punching and subsequent press working with a bending die or a drawing die using a press working apparatus equipped with an uncoiler while it was fed with a measuring roll.

In a test with materials other than the conventional materials, press workability was evaluated in the following manner with respect to slippage of a material to be tested during feeding with a measuring roll and removability of punched blanks (whether a plurality of blanks were transported to a, press working machine as stacked one on another by failure to be pulled apart due to sticking of the blanks to each other):

◯: material of a prescribed length could be fed without slipping by a measuring roll, the removability of blanks after punching was good, and there were no problems at all in a series of press working steps;

Δ: there was no slip when the material was fed by a measuring roll, but when a blank was transferred after punching, there was a tendency for troubles after punching to occur such as for a plurality of blanks to be transported as stacked;

×: slippage occurred when the material was fed by a measuring roll, and a series of press working steps could not be performed in a stable manner.

With the conventional material, the problems of press working were not slippage at the time of transport or blanks sticking to each other, but were a decrease in the service life of dies due to wear of the dies caused by the surface film being too hard. Therefore, the extent of wear of the dies during continuous punching was used to evaluate press workability by comparing the height of burrs formed by punching, which was determined on a cut cross section of a blank, with that for a cold rolled steel strip. The height of burrs on a cut cross section of a blank increases as working (punching) is repeated with a die. The press workability was evaluated in terms of the rate at which the height of burrs increases as working is repeated with a die. Thus, it was indicated as ◯ when there was no substantial difference in that rate from a cold rolled steel strip, as Δ when the rate is slightly higher than for a cold rolled steel strip, and as × when the rate is significantly higher than for a cold rolled steel strip.

Spot Weldability

Continuous spot welding was performed under the following conditions IS which were selected as average conditions employed by users while the state of welding (including occurrence of non-conducting failure and expulsions, size of expulsions if any, and wastage of electrode tips during continuous spot welding) was checked:
electrode tips: round tips of pure copper with a diameter of 5 mm for both the upper and lower electrodes,

load: 5 kgf, electric current: 600 A, and frequency: 6 cycles. The results were evaluated by the number of normally weldable spots forming regular nuggets by normal conducting with inappreciable wastage of electrode tips as follows:
◯: 10,000 spots or more,
Δ: 5,000-10,000 spots,
×: less than 5,000 spots.

Corrosion Resistance

Test pieces obtained by cutting the inner magnetic shield material to 50 mm×100 mm were coated on their surface with a usual rust preventing oil for steel strips (mineral oil based) and were then subjected to degreasing and washing under standard conditions, and the corrosion resistance was then evaluated in an air exposure test. The air exposure test was carried out for 30 days in an environment in which the test pieces were not wetted by rain or the like. The corrosion resistance was evaluated in the following manner by the state of development of rust observed on the test pieces after the 30 day test period:

◯: no rust developed at all,

Δ: some spot rust developed,

×: considerable rust developed.

The test period was made 30 days because in the production of an actual inner magnetic shield, unless there is some accident, a longer storage period is not necessary, and the environment of the air exposure test was one having a higher tendency towards corrosion than the environment of an actual site of use.

Film Combustibility

After the surface of the same test piece as described above was coated with a usual rust preventing oil for steel strips (mineral oil based), degreasing and washing were carried out for as short a degreasing and washing time as possible in a situation in which a cold rolled steel strip could be degreased. Then, it was heated in air at 450° C. for 40 minutes. The heating conditions were set so as to simulate the sealing step of a CRT. It was determined by EPMA analysis whether resin remained on the surface of the test piece after heating. In addition, the amount of gas generated in the heat treatment was measured over time to ascertain whether the generation of gas ceased during the heat treatment of the sealing step. Furthermore, a gas sample was analyzed by the TG-MS method and the Pyro-GC-MS method to check whether any corrosive gas containing S, Cl, F, or the like was generated.

For the results, the case in which a resin did not remain after heat treatment under the above-described conditions, the generation of gas ceased during heat treatment, and a corrosive gas was not generated was indicated as ◯, and the case in which it was ascertained that some resin remained, or in which the generation of gas did not cease during heat treatment, or in which a corrosive gas was generated was indicated as ×.

For the conventional materials, the film does not combust, so the properties other than whether a resin coating film remained, i.e., whether the generation of gas ceased during heat treatment or whether a corrosive gas was generated were evaluated in the same manner as described above.

TABLE 5

| | Ra of steel | Organic resin coating film | | | Press | Spot | | |
|---|---|---|---|---|---|---|---|---|
| Run No. | (μm) | Resin type | T(μ) | T/Ra | workability | weldability | CR¹ | FC² |
| 1 | 0.21 | Urethane | 2.20 | 10.48* | ◯ | X | ◯ | ◯ |
| 2 | 0.42 | ″ | 2.00 | 4.76* | ◯ | X | ◯ | ◯ |
| 3 | 0.80 | ″ | 2.30 | 2.88 | ◯ | Δ | ◯ | ◯ |
| 4 | 0.97 | ″ | 2.30 | 2.37 | ◯ | ◯ | ◯ | ◯ |
| 5 | 1.20 | ″ | 2.10 | 1.75 | ◯ | ◯ | ◯ | ◯ |
| 6 | 3.00 | ″ | 2.00 | 0.67 | ◯ | ◯ | ◯ | ◯ |
| 7 | 0.23 | ″ | 0.30 | 1.30 | ◯ | ◯ | ◯ | ◯ |
| 8 | 0.95 | ″ | 1.50 | 1.58 | ◯ | ◯ | ◯ | ◯ |
| 9 | 1.21 | ″ | 3.20 | 2.64 | ◯ | Δ | ◯ | ◯ |
| 10 | 1.15 | ″ | 5.00 | 4.35* | ◯ | X | ◯ | ◯ |
| 11 | 0.92 | ″ | 0.80 | 0.87 | ◯ | ◯ | ◯ | ◯ |
| 12 | 1.77 | ″ | 3.20 | 1.81 | ◯ | ◯ | ◯ | ◯ |
| 13 | 0.85 | Urethane + Acrylic | 0.90 | 1.06 | ◯ | ◯ | ◯ | ◯ |
| 14 | 1.52 | Urethane + Acrylic | 2.80 | 1.84 | ◯ | ◯ | ◯ | ◯ |
| 15 | 1.10 | Urethane + SiO₂ (5%) | 2.20 | 2.00 | ◯ | ◯ | ◯ | ◯ |
| 16 | 0.97 | Urethane + SiO₂ (50%) | 1.90 | 1.96 | ◯ | ◯ | ◯ | ◯ |
| 17 | 0.12* | Urethane | 2.00 | 16.67* | X | X | ◯ | ◯ |
| 18 | 0.17* | ″ | 2.20 | 12.94* | Δ˜X | X | ◯ | ◯ |
| 19 | 0.85 | ″ | 0.10 | 0.12* | ◯ | ◯ | X | ◯ |
| 20 | 0.92 | ″ | 5.70 | 6.20* | ◯ | X | ◯ | X |
| 21 | 0.87 | ″ | 6.80* | 7.82* | ◯ | X | ◯ | X |
| 22 | 0.45 | Bare steel strip | 0* | 0* | ◯ | ◯ | X | ◯ |
| 23 | 0.65 | Urethane | 0.07 | 0.10* | ◯ | ◯ | X | ◯ |
| 24 | 0.52 | ″ | 0.06 | 0.12* | ◯ | ◯ | X | ◯ |
| 25 | 0.43 | ″ | 0.06 | 0.15* | ◯ | ◯ | X | ◯ |
| 26 | 0.77 | ″ | 0.08 | 0.10* | ◯ | ◯ | X | ◯ |
| 27 | 0.50 | ″ | 0.15 | 0.30 | ◯ | ◯ | Δ | ◯ |
| 28 | 0.44 | ″ | 0.15 | 0.35 | ◯ | ◯ | Δ | ◯ |
| 29 | 0.41 | ″ | 0.16 | 0.38 | ◯ | ◯ | Δ | ◯ |
| 30 | 0.32 | ″ | 0.06 | 0.20 | ◯ | ◯ | Δ | ◯ |
| 31 | 0.20 | ″ | 0.05 | 0.25 | ◯ | ◯ | Δ | ◯ |
| 32 | 0.39 | ″ | 0.18 | 0.45 | ◯ | ◯ | ◯ | ◯ |
| 33 | 0.47 | ″ | 0.23 | 0.48 | ◯ | ◯ | Δ | ◯ |
| 34 | 0.25 | ″ | 0.15 | 0.60 | ◯ | ◯ | ◯ | ◯ |
| 35 | 0.22 | ″ | 0.12 | 0.55 | ◯ | ◯ | ◯ | ◯ |
| 36 | 0.38 | ″ | 0.25 | 0.67 | ◯ | ◯ | ◯ | ◯ |
| 37 | 0.47 | ″ | 0.29 | 0.62 | ◯ | ◯ | ◯ | ◯ |
| 38 | 0.41 | ″ | 0.21 | 0.52 | ◯ | ◯ | ◯ | ◯ |
| 39 | 0.81 | ″ | 2.43 | 3.00 | ◯ | Δ | ◯ | ◯ |
| 40 | 0.52 | ″ | 1.72 | 3.30 | ◯ | Δ | ◯ | ◯ |
| 41 | 0.33 | ″ | 1.16 | 3.50 | ◯ | Δ | ◯ | ◯ |
| 42 | 0.41 | ″ | 1.64 | 4.00 | ◯ | Δ | ◯ | ◯ |
| 43 | 3.32* | ″ | 2.10 | 0.63 | ◯ | ◯ | X | ◯ |

| | | | | | | | |
|---|---|---|---|---|---|---|---|
| 44 | 0.82 | Ni plating + Annealing | — | Δ | Δ | Δ | X |
| 45 | 0.57 | FeO-based blackened film | — | X | Δ | X | X |

*Outside the preferable range;
¹Corrosion resistance;
²Film combustibility

As can be seen from Table 5, when the surface roughness of the steel strip was less than 0.2 μm Ra, the press workability was inferior. When the surface roughness exceeded 3 μm, the corrosion resistance was inferior. The spot weldability began to become inferior when the ratio T/Ra was greater than 2.5 and was significantly deteriorated when this ratio was greater than 4. When the ratio T/Ra was less than 0.4, the corrosion resistance began to become inferior and it was significantly deteriorated at a ratio T/Ra which was less than 0.2.

As shown in Example 1, a metal oxide contained in the organic resin coating film served to improve the reddishness during oxidation at a high temperature, and it lo did not interfere with the properties tested in this example.

### Example 5

Using low carbon, aluminum killed steels a-e having the compositions shown in Table 6 (remainder: Fe and unavoidable impurities), cold rolled steel strips having a surface roughness of 0.5 μm and a thickness of 0.15 mm were obtained by hot rolling and cold rolling. These cold rolled steel strips were annealed by heat treatment at 800° C. for 5 seconds in an N₂ atmosphere in continuous annealing equipment.

The cold rolled steel strips were then pretreated by alkaline degreasing and then washing with hot water according to Run No. 3 in Table 2. The conditions for each treatment were the same as in Example 1.

On the pretreated steel strips, a urethane-based organic resin coating film having a thickness of 1.7 μm was formed in the same manner as in Example 1 to prepare inner magnetic shield materials.

A test piece of each material prepared above was subjected to heat treatment in the same manner as employed in Example 1 to evaluate the reddishness (450° C. in air for 120 minutes), and the adhesion of the scale formed by this heat treatment was evaluated by a peeling test with a clear plastic adhesive tape in the following manner:

◯: good adhesion of the scale with no peeling,

Δ: slight peeling occurred,

×: delamination or peeling of the scale in a film form occurred.

The reddishness of the test piece after the heat treatment was also evaluated in the same manner as in Example 1. The results of these evaluations are also shown in Table 6.

TABLE 6

| | Steel composition (wt %) | | | | | | | | | |
|---|---|---|---|---|---|---|---|---|---|---|
| Mark | C | Si | Mn | P | S | Al | [Si] + [Al] | [Al] − [Si] | Adhesion | Reddishness |
| a | 0.002 | 0.1 | 0.27 | 0.09 | 0.003 | 0.3 | 0.4 | 0.2 | ◯ | ◯ |
| b | 0.003 | 0.005* | 0.27 | 0.08 | 0.005 | 0.001 | 0.006* | −0.004* | ◯ | X |
| c | 0.003 | 1.0 | 0.26 | 0.10 | 0.003 | 0.001 | 1.001* | −0.999* | X | ◯ |
| d | 0.002 | 0.15 | 0.28 | 0.09 | 0.004 | 0.1 | 0.25 | −0.05* | Δ | Δ |
| e | 0.002 | 0.3 | 0.27 | 0.09 | 0.004 | 0.35 | 0.65* | 0.05 | X | ◯˜Δ |

*Outside the preferable range

It can be seen from Table 6 that when the steel composition satisfied all the following conditions:
[Si]≧0.02, 0.25≦[Si]+[Al]≦0.55, 0.05≦[Al]−[Si]≦0.35
in accordance with a preferred embodiment of the present invention, the scale formed by oxidization at a high temperature was a magnetite-based oxide film (scale) having good adhesion.

1-15. (canceled)

16. An inner magnetic shield material for use in manufacturing an inner magnetic shield to be installed inside a color picture tube, comprising a steel strip having a coating film of an organic resin which consists essentially of C and H, or of C, H, and O, or of C, H, O, and N on at least one surface of the steel strip,
wherein the at least one surface of the steel strip has a surface roughness (Ra) of 0.2-3 μm, the organic resin coating film has a thickness (T) of 0.1-6 μm, and the ratio T/Ra is in the range of 0.2-4.0.

17. An inner magnetic shield material for use in manufacturing an inner magnetic shield to be installed inside a color picture tube, comprising a steel strip having a coating film of an organic resin which consists essentially of C and H, or of C, H, and O, or of C, H, O, and N on at least one surface of the steel strip,
wherein the at least one surface of the steel strip has a surface roughness (Ra) of 0.2-3 μm, the organic resin coating film has a thickness (T) of 0.1-6 μm, and this coating film contains particles of a wax dispersed therein, wherein the ratio (φ/T) of average particle diameter (φ) of the wax to film thickness (T) is in the range of 0.5-5, and the content of the wax in the film is such that 2-20% of the surface of the coating film is occupied by the wax when the surface is observed under an electron microscope.

18. The inner magnetic shield material as claimed in claim 17, wherein the ratio T/Ra is in the range of 0.2-4.0.

19. The inner magnetic shield material as claimed in claim 16, wherein the organic resin coating film contains one of (a) at least one coupling agent in a total amount of 2-50 wt % and (b) at least one metal oxide selected from SiO₂, Fe₃O₄, Fe₂O₃, Ni—O, Zr—O, Cr₂O₃, and Al₂O₃ in a total amount of 2-80 wt %, or both (a) and (b).

20. The inner magnetic shield material as claimed in claim 16, wherein the organic resin is combustible for decomposition by heating in air at a temperature of 450° C. or below.

21. The inner magnetic shield material as claimed in claim 16, wherein the Si and Al contents ({Si} and {Al], respectively, in wt %) of the steel strip satisfy the following inequalities:
[Si]≧0.02, 0.25≦[Si]+[Al]≦0.55, 0.05≦[Al]−[Si]≦0.35.

22. The inner magnetic shield material as claimed in claim 16, wherein the steel strip has a plated film with a coating weight of 0.1-20 g/m² as a primary coat under the organic resin coating film, the plated film being formed of a metal selected from Ni, Cr, and Fe or an alloy based on the metal.

23. A method of manufacturing an inner magnetic shield material comprising forming a coating film of an organic resin consisting essentially of C and H, or of C, H, and O, or of C, H, O, and N on at least one surface of a cold rolled steel strip or pickled hot rolled steel strip,
wherein the at least one surface of the steel strip has a surface roughness (Ra) of 0.2-3 μm, the organic resin coating film has a thickness (T) of 0.1-6 μm, and the ratio T/Ra is in the range of 0.2-4.0.

24. A method of manufacturing an inner magnetic shield material comprising forming a coating film of an organic resin consisting essentially of C and H, or of C, H, and O, or of C, H, O, and N on at least one surface of a cold rolled steel strip or pickled hot rolled steel strip,
wherein the at least one surface of the steel strip has a surface roughness (Ra) of 0.2-3 μm, the organic resin coating film has a thickness (T) of 0.1-6 μm, and this coating film contains particles of a wax dispersed therein, wherein the ratio (φ/T) of average particle diameter of the wax (φ) to film thickness (T) is in the range of 0.5-5, and the content of the wax in the film is such that 2-20% in area of the surface of the coating film is occupied by the wax when the surface is observed under an electron microscope.

25. The method as claimed in claim 24, wherein the ratio T/Ra is in the range of 0.2-4.0.

26. The method as claimed in claim 23, wherein the organic resin coating film contains one of (a) at least one coupling agent in a total amount of 2-50 wt % and (b) at least one metal oxide selected from SiO₂, Fe₃O₄, Fe₂O₃, Ni—O, Zr—O, Cr₂O₃, and Al₂O₃ in a total amount of 2-80 wt %, or both (a) and (b).

27. The method as claimed in claim 23, wherein the cold rolled steel strip or pickled hot rolled steel strip is subjected, prior to the formation of the organic resin coating film to pretreatment by applying one of (1) an acid selected from hydrochloric acid, sulfuric acid, nitric acid, and a mixture of these and (2) an acidic solution containing ions of at least one metal selected from Ni, Co, Fe, Zr, Sb, V, Mo, and W, or both (1) and (2).

28. The method as claimed in claim 23, wherein the cold rolled steel strip or pickled hot rolled steel strip is subjected, prior to the formation of the organic resin coating film, to plating with a metal selected from Ni, Cr, and Fe or an alloy based on the metal to form a plated film with a coating weight of 0.1-20 g/m₂.

29. An inner magnetic shield manufactured from the inner magnetic shield material as claimed in claim 1 without blackening treatment.

30. A color picture tube having an inner magnetic shield as claimed in claim 29.
